(19) United States
(12) Patent Application Publication
(10) Pub. No.: US 2023/0279651 A1
(43) Pub. Date: Sep. 7, 2023

(54) DIGITAL CONTROL DEVICE BASED ON ARTIFICIAL INTELLIGENCE

(71) Applicant: Shanghai University of Engineering Science, Shanghai (CN)

(72) Inventors: Zhijun Fang, Shanghai (CN); Jiali Xu, Shanghai (CN); Xiaoli Zhao, Shanghai (CN)

(21) Appl. No.: 17/828,700

(22) Filed: May 31, 2022

(30) Foreign Application Priority Data
Mar. 7, 2022 (CN) 202210214679.9

(51) Int. Cl. E03D 9/04; F24F 11/30; F24F 11/56

(52) U.S. Cl. CPC E03D 9/04; F24F 11/30; F24F 11/56; F24F 2110/10

(57) ABSTRACT

The present disclosure relates to a digital control device based on artificial intelligence, belonging to the technical field of intelligent control. The digital control device based on artificial intelligence used by the present disclosure can comprehensively monitor the environmental data including temperature, humidity, smoke concentration, oxygen content, infrared temperature signals, etc. in real time by providing a control system, an environmental monitoring system and an actuating system, and generate control instructions through the monitored environmental data so that the actuating system can make corresponding actions accordingly, thus solving the problems existing problems in the prior art that the monitoring comprehensiveness is low, misjudgments or missed judgments are easy to occur, sensors cannot collect external environmental information in a time-sharing manner, and the practicability and service life are short.

### CROSS REFERENCE TO RELATED APPLICATION

This patent application claims the benefit and priority of Chinese Patent Application No. 202210214679.9, filed on Mar. 7, 2022, the disclosure of which is incorporated by reference herein in its entirety as part of the present application.

### TECHNICAL FIELD

The present disclosure relates to the technical field of intelligent control, in particular to a digital control device based on artificial intelligence.

### BACKGROUND ART

With the increasing demand for people's quality of life, the number of large and medium-sized bathing places in urban and rural areas has increased rapidly. At the same time, family bathrooms have become the necessity for residential design. However, with the increase of potential safety hazards, accidents and casualties occur frequently. Among many accidents, the probability of accidents in leisure and holiday centers such as large bathing places and hot springs in cities and towns is higher. It is difficult to measure and display environmental reference values such as humidity and temperature of bathing places in most leisure places in real time. When the values exceed a certain threshold, people in the places will feel uncomfortable, especially in summer, which is easy to cause personal accidents. If first-aid measures such as cutting off hot water supply, strengthening indoor ventilation and calling medical rescue personnel in places cannot be taken immediately, it may lead to casualties and unimaginable consequences.

### SUMMARY

In order to solve the above problems in the prior art, the present disclosure provides a digital control device based on artificial intelligence.

In order to achieve the above object, the present disclosure provides the following solutions.

A digital control device based on artificial intelligence comprises: a control system, an environmental monitoring system and an actuating system;
wherein the environmental monitoring system and the actuating system are both connected with the control system; the environmental monitoring system is configured to acquire environmental data; the environmental data includes temperature, humidity, smoke concentration, oxygen content and infrared temperature signals;
the control system is configured to generate a control instruction according to the environmental data; the control instruction includes a water flow control instruction, an exhaust rotating speed control instruction, a power switch instruction and an alarm instruction;
the actuating system is configured to perform corresponding action processing according to the control instruction.

Preferably, the environmental monitoring system comprises a humidity monitoring module, a temperature monitoring module, an oxygen content monitoring module, a smoke monitoring module, and an infrared temperature monitoring module;
the humidity monitoring module, the temperature monitoring module, the oxygen content monitoring module, the smoke monitoring module and the infrared temperature monitoring module are all connected with the control system.

Preferably, the actuating system comprises an alarm module, a hot and cold water flow control module, an exhaust fan rotating speed control module and a main power switch module;
the alarm module, the hot and cold water flow control module, the exhaust fan rotating speed control module and the main power switch module are all connected with the control system.

Preferably, the control system comprises an information processing module, an AI control module and a central processing unit;
the information processing module is connected with the environmental monitoring system and the central processing unit, respectively; the AI control module is connected with the actuating system and the central processing unit, respectively;
the information processing module is configured to preprocess the environmental data; the central processing unit is configured to generate a control signal according to the processed environmental data; and the AI control module is configured to generate the control instruction according to the control signal.

Preferably, the control system further comprises a storage module and a wireless signal transmission module;
the storage module and the wireless signal transmission module are both connected with the central processing unit; the storage module is configured to store the preprocessed environmental data; and the wireless transmission module is configured to communicate with a remote terminal.

Preferably, the remote terminal is a mobile client.

Preferably, the digital control device based on artificial intelligence further comprises an auxiliary system;
wherein the auxiliary system is connected with the central processing unit.

Preferably, the auxiliary system comprises a display module, a voice playing module, a control switch module and an instruction input module;
the display module, the voice playing module, the control switch module and the instruction input module are all connected with the central processing unit.

Preferably, the digital control device based on artificial intelligence further comprises: a shell;
the control system and the actuating system are provided with the environmental data inside the shell.

Preferably, the shell is provided with a side flip cover.

According to the specific embodiment provided by the present disclosure, the present disclosure discloses the following technical effects.

The digital control device based on artificial intelligence used by the present disclosure can comprehensively monitor the environmental data including temperature, humidity, smoke concentration, oxygen content, infrared temperature signals, etc. in real time by providing a control system, an environmental monitoring system and an actuating system, and generate control instructions through the monitored environmental data so that the actuating system can make corresponding actions accordingly, thus solving the problems existing problems in the prior art that the monitoring comprehensiveness is low, misjudgments or missed judgments are easy to occur, sensors cannot collect external environmental information in a time-sharing manner, and the practicability and service life are short.

### BRIEF DESCRIPTION OF THE DRAWINGS

In order to explain the embodiments of the present disclosure or the technical solutions in the prior art more clearly, the drawings that need to be used in the embodiments will be briefly introduced. Obviously, the drawings in the following description are merely some embodiments of the present disclosure. For those skilled in the art, other drawings can be obtained according to these drawings without any creative effort.

FIG. 1 is a schematic structural diagram of a digital control device based on artificial intelligence according to the present disclosure.

FIG. 2 is a schematic diagram of the front view structure of a digital control device based on artificial intelligence according to an embodiment of the present disclosure.

FIG. 3 is a first control flow chart of a digital control device based on artificial intelligence according to an embodiment of to the present disclosure.

FIG. 4 is a second control flow chart of a digital control device based on artificial intelligence according to an embodiment of the present disclosure.

### DESCRIPTION OF REFERENCE NUMBERS

1—wireless signal transmission module, 2—central processing unit, 3—AI control module, 4—storage module, 5—power supply module, 6—information processing module, 7—hot and cold water flow control module, 8—exhaust fan rotating speed control module, 9—main power switch module, 10—alarm module, 11—voice playing module, 12—instruction input module, 13—control switch module, 14—display module, 15—infrared temperature monitoring module, 16—oxygen content monitoring module, 17—smoke monitoring module, 18—temperature monitoring module, 19—humidity monitoring module, 20—shell, 21—temperature sensor, 22—humidity sensor, 23—oxygen content sensor, 24—smoke sensor, 25—infrared temperature sensor.

### DETAILED DESCRIPTION OF THE EMBODIMENTS

The technical solutions in the embodiments of the present disclosure will be clearly and completely described with reference to the drawings in the embodiments of the present disclosure hereinafter. Obviously, the described embodiments are only part of the embodiments of the present disclosure, rather than all of the embodiments. Based on the embodiment of the present disclosure, all other embodiments obtained by those skilled in the art any creative effort fall within the scope of protection of the present disclosure.

The purpose of the present disclosure is to provide a digital control device based on artificial intelligence, which can monitor and alarm the environmental data of different indoor scenes, so as to realize the overall intelligent monitoring of the place environment.

In order to make the above objects, features and advantages of the present disclosure more obvious and understandable, the present disclosure will be explained in further detail with reference to the drawings and detailed description hereinafter.

The digital control device based on artificial intelligence provided by the present disclosure comprises a control system, an environmental monitoring system and an actuating system.

The environmental monitoring system and the actuating system are both connected with the control system. The environmental monitoring system is configured to acquire environmental data. The environmental data includes temperature, humidity, smoke concentration, oxygen content and infrared temperature signals.

The control system is configured to generate a control instruction according to the environmental data. The control instruction includes a water flow control instruction, an exhaust rotating speed control instruction, a power switch instruction and an alarm instruction.

The actuating system is configured to perform corresponding action processing according to the control instruction.

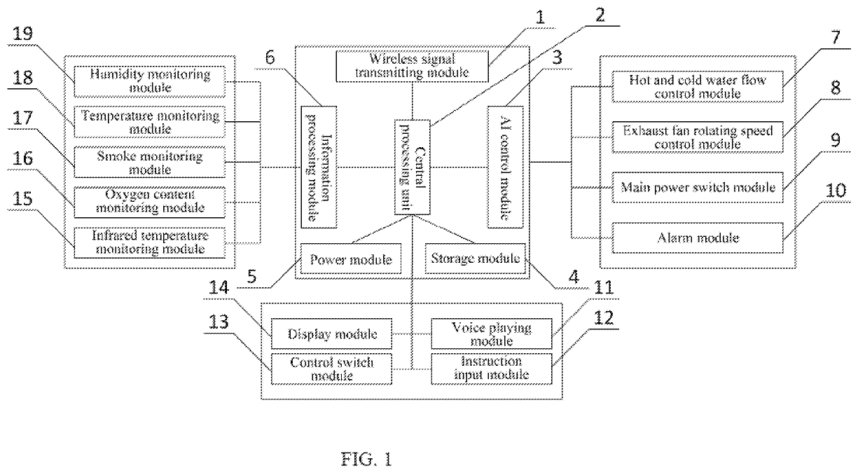

As shown in FIG. 1, the environmental monitoring system comprises a humidity monitoring module 19, a temperature monitoring module 18, an oxygen content monitoring module 16, a smoke monitoring module 17 and an infrared temperature monitoring module 1815.

The humidity monitoring module 19, the temperature monitoring module 18, the oxygen content monitoring module 16, the smoke monitoring module 17 and the infrared temperature monitoring module 1815 are all connected with the control system.

The humidity monitoring module 19 using a humidity sensor 22 to sense the humidity value of the environment. The temperature monitoring module 18 uses a humidity sensor 22 to sense the temperature value of the environment. The oxygen content monitoring module 16 uses an oxygen content sensor 23 to sense the oxygen content value of the environment. The smoke monitoring module 17 uses a smoke sensor 24 to sense the smoke concentration value of the environment. The infrared temperature monitoring module 1815 uses an infrared temperature sensor 25 to sense the infrared temperature value of the environment.

The actuating system comprises an alarm module 10, a hot and cold water flow control module 7, an exhaust fan rotating speed control module 8 and a main power switch module 9.

The alarm module 10, the hot and cold water flow control module 7, the exhaust fan rotating speed control module 8 and the main power switch module 9 are all connected with the control system.

The hot and cold water flow control module 7 can change the valve flow or close the valve.

The exhaust fan rotating speed control module 8 can change the exhaust fan rotating speed or turn off the exhaust fan.

The main switch module 9 can turn on or off the back-end main power supply.

The alarm module 10 comprises a buzzer and a flash device, and can continuously issue alarm signals, so as to prevent the staff from missing the operation time because they cannot find the alarm signals.

The control system comprises an information processing module 6, an AI control module 3 and a central processing unit 2.

The information processing module 6 is connected with the environmental monitoring system and the central processing unit 2, respectively. The AI control module 3 is connected with the actuating system and the central processing unit 2, respectively.

The information processing module 6 is configured to preprocess the environmental data. The central processing unit 2 is configured to generate a control signal according to the processed environmental data. The AI control module 3 is configured to generate the control instruction according to the control signal.

The information processing module 6 receives the values in the place detected by various sensors, judges whether the received environmental humidity, environmental temperature, environmental oxygen content, environmental smoke concentration and environmental infrared temperature exceed the corresponding threshold or the values are higher or lower within the threshold range, and then transmits the processed information to the central processing unit 2.

The AI control module 3 is connected with the central processing unit 2, performs intelligent data analysis according to various environmental values, and sends instructions to the alarm module 10, the hot and cold water flow control module 7, the exhaust fan rotating speed control module 8 and the main power switch module 9 according to the analysis results. If the environmental humidity is higher within the threshold range or exceeds the threshold range, the exhaust fan rotating speed control module 8 increases the exhaust fan rotating speed. If the environmental humidity is lower or below the threshold range, the exhaust fan rotating speed control module 8 reduces the exhaust fan rotating speed or turns off the exhaust fan.

For example, if the environmental temperature is higher within the threshold range or exceeds the threshold range, the hot and cold water flow control module 7 increases the valve flow. If the environmental temperature is lower or below the threshold range, the hot and cold water flow control module 7 reduces the valve flow and/or turns off the valve.

If the environmental oxygen content is higher within the threshold range or exceeds the threshold range, the exhaust fan rotating speed control module 8 increases the exhaust fan rotating speed. If the environmental oxygen content is lower or below the threshold range, the exhaust fan rotating speed control module 8 reduces the exhaust fan rotating speed or turns off the exhaust fan.

If the environmental smoke concentration exceeds the threshold range, the alarm module 10 continuously issues an alarm signal, and the main power switch module 9 turns off the power supply.

If the environmental infrared temperature exceeds the threshold range, the alarm module 10 continuously issues an alarm signal, and the main power switch module 9 turns off the power supply.

In order to facilitate the real-time viewing of the monitored data, troubleshooting of the fault causes and the real-time monitoring, the control system provided by the present disclosure further comprises a storage module 4 and a wireless signal transmission module 1.

The storage module 4 and the wireless signal transmission module 1 are both connected with the central processing unit 2. The storage module 4 is configured to store the preprocessed environmental data. The wireless signal transmitting module 1 is connected with the central processing unit 2, and sends to the mobile client the situation whether the environmental humidity, environmental temperature, environmental oxygen content, environmental smoke concentration and environmental infrared temperature exceed the corresponding threshold or the values are higher or lower within the threshold range.

Further, in order to facilitate the user to set the device parameters according to the use environment, the digital control device based on artificial intelligence provided by the present disclosure further comprises an auxiliary system. The auxiliary system is connected with the central processing unit 2.

The auxiliary system comprises a display module 14, a voice playing module 11, a control switch module 13 and an instruction input module 12.

The switch module 13 is connected with the central processing unit 2 and controls ON/OFF of the whole digital control device.

The display module 14 is connected with the central processing unit 2 and displays various values. When the environmental values need to ask the user for operation instructions, the display requires the user to operate.

The voice playing module 11 is connected with the central processing unit 2, and when the environmental value needs to ask the user for operation instructions, it will prompt the user to operate using voice.

The instruction module 12 is connected to the central processing unit 2 and is configured to receive operation instructions input by a user.

Further, in order to prevent each system in the device from being damaged, the present disclosure provides a shell 20. The control system and the actuating system are provided inside the shell 20. Various sensors are provided on the side of the flip cover of the shell 20 to facilitate the detection of environmental data.

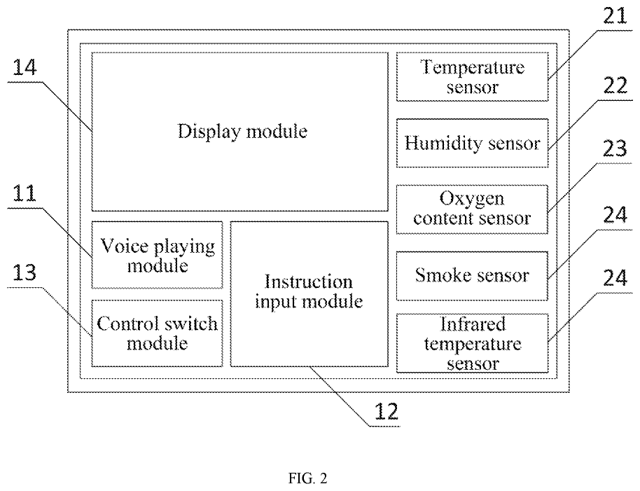

In order to facilitate the operation of the user, the shell 20 is provided with a side flip cover. For example, the shell 20 is provided with a flip cover on the left side. A display interface and an instruction input key are provided inside the flip cover of the shell 20. A temperature sensor 21, a humidity sensor 22, an oxygen content sensor 23, a smoke sensor 24 and an infrared temperature sensor 25 are provided on the right side of the shell 20, as shown in FIG. 2.

Further, in order to improve the accuracy and efficiency of data processing, the digital control device based on artificial intelligence provided by the present disclosure analyzes related environmental values using a neural network analysis method, and intelligently makes corresponding control measures. Specifically:

the neural network inputs the environmental values detected by each sensor. The neural network outputs the command signal of the back-end control device. The control device has a fixed threshold range set by the staff. However, under different requirements, the appropriate values of the environmental values within the threshold range are different in different places. The central value of the environmental values will deviate from the actual needs of users, so that the control device adjusts the environmental values by mistake. In this process, through the intervention of staff, the information processing module automatically learns whether the environmental values within the threshold range are higher or lower, and adjusts the environmental values. Finally, the control system learns the reasonable environmental center values of the place and eliminate the abnormal environmental values, thus reducing the incorrect adjustment actions of the control device.

If the environmental humidity is higher within the threshold range or exceeds the threshold range, the exhaust fan rotating speed control module 8 increases the exhaust fan rotating speed. If the environmental humidity is lower or below the threshold range, the exhaust fan rotating speed control module 8 reduces the exhaust fan rotating speed or turns off the exhaust fan.

If the environmental temperature is higher within the threshold range or exceeds the threshold range, the hot and cold water flow control module 7 increases the valve flow. If the environmental temperature is lower or below the threshold range, the hot and cold water flow control module 7 reduces the valve flow and/or turns off the valve.

If the environmental oxygen content is higher within the threshold range or exceeds the threshold range, the exhaust fan rotating speed control module 8 increases the exhaust fan rotating speed. If the environmental oxygen content is lower or below the threshold range, the exhaust fan rotating speed control module 8 reduces the exhaust fan rotating speed or turns off the exhaust fan.

If the environmental smoke concentration exceeds the threshold range, the alarm module 10 continuously issues an alarm signal, and the main power switch module 9 turns off the power supply.

If the environmental infrared temperature exceeds the threshold range, the alarm module 10 continuously issues an alarm signal, and the main power switch module 9 turns off the power supply.

In the non-business state of the place, the staff can strictly set it t in the AI control module 3 in advance in the laboratory design stage according to their own needs, and learn and confirm the relevant environmental values in the actual operation, so as to make accurate analysis.

In addition, the present disclosure is further provided with a power supply module 5, so as to provide suitable electric energy for the whole device.

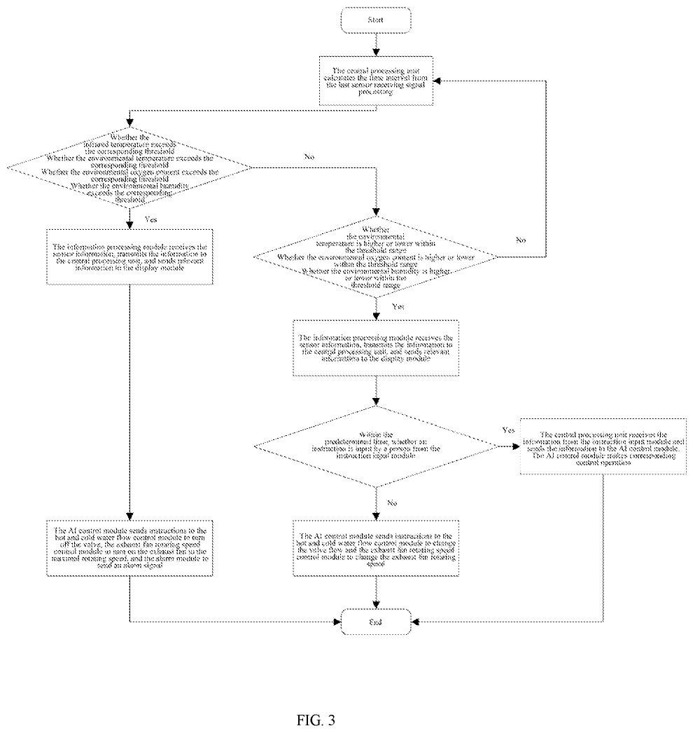

As shown in FIG. 3, the business state control flow of a digital control device based on artificial intelligence according to this embodiment comprises the following steps.

S1. The central processing unit 2 calculates the time interval from the last sensor receiving signal processing.

S2. The central processing unit 2 receives the infrared temperature, environmental temperature, environmental humidity and environmental oxygen content values output by the temperature sensor 21, the humidity sensor 22, the oxygen content sensor 23 and the infrared temperature sensor 25 from the information processing module 6, and judges whether the values exceed the corresponding thresholds.

S3. If a certain value exceeds the corresponding threshold, the central processing unit 2 sends relevant information to the display module 14. The AI control module 3 sends instructions to the hot and cold water flow control module 7 to turn off the valve, the exhaust fan rotating speed control module 8 to turn on the exhaust fan to the maximal rotating speed, and the alarm module 10 to send an alarm signal.

S4. If all the values do not exceed the corresponding thresholds, the central processing unit 2 receives the infrared temperature, environmental temperature, environmental humidity and environmental oxygen content output by the temperature sensor 21, the humidity sensor 22, the oxygen content sensor 23 and the infrared temperature sensor 25 from the information processing module 6, and judges whether the values are higher or lower within the threshold range.

S5. If the value is higher or lower within the threshold range, the central processing unit 2 sends relevant information to the display module 14. If the value is within the normal threshold range, step S1 is executed.

S6. Within the predetermined time, the central processing unit 2 judges whether an instruction is input by a person from the instruction input module 12.

S7. If an instruction is input by a person during the period, the central processing unit 2 receives the information from the instruction input module 12 and sends the information to the AI control module 3. The AI control module 3 makes corresponding control operation. Otherwise, the AI control module 3 sends instructions to the hot and cold water flow control module 7 to change the valve flow and the exhaust fan rotating speed control module 8 to change the exhaust fan rotating speed.

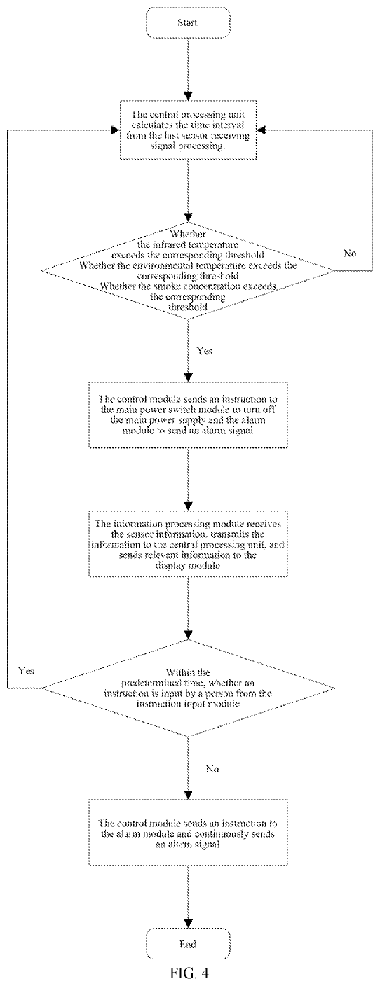

As shown in FIG. 4, the non-business state control flow of the digital control device based on artificial intelligence according to this embodiment comprises the following steps.

S1. The central processing unit 2 calculates the time interval from the last sensor receiving signal processing.

S2. The central processing unit 2 receives the infrared temperature, environmental temperature and environmental smoke concentration values output by the temperature sensor 21, the smoke sensor 24 and the infrared temperature sensor 25 from the information processing module 6, and judges whether the values exceed the corresponding thresholds.

S3. If a certain value exceeds the corresponding threshold, the central processing unit 2 sends relevant information to the AI control module 3. The AI control module 3 sends an instruction to the main power switch module 9 to turn off the main power supply and the alarm module 10 to send an alarm signal. The central processing unit 2 sends relevant information to the display module 14. Otherwise, step S1 is executed.

S4. Within the predetermined time, the central processing unit 2 judges whether an instruction is input by a person from the instruction input module 12. If an instruction is input by a person during the period, step S1 is executed. Otherwise, the AI control module 3 sends an instruction to the alarm module 10 and continuously sends an alarm signal.

Based on the above description, the present disclosure has the following advantages over the prior art.

1. The present disclosure solves the problems in the prior art that there is no effective intelligent control device for environmental factors in large and medium-sized bathing places and family bathrooms in urban and rural areas, the monitoring comprehensiveness is low, misjudgments or missed judgments are easy to occur, sensors cannot collect external environmental information in a time-sharing manner, and the practicability and service life are short.

2. The present disclosure solves the problems of detection of the scene safety, intelligent processing of abnormal phenomena, and real-time alarm when large bathing places or family bathrooms are not in use at the present stage.

3. The present disclosure is convenient to use, and the flip cover design ensures that the components on the control device will not be damaged in the humid application environment of the shell. At the same time, each functional control module is reasonably provided, which is beneficial to the later repair and maintenance.

In this specification, each embodiment is described in a progressive way, and the differences between each embodiment and other embodiments are highlighted. The same and similar parts between various embodiment can be referred to each other.

In the present disclosure, specific examples are used to explain the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of this specification should not be construed as limiting the present disclosure.

What is claimed is:

1. A digital control device based on artificial intelligence, comprising: a control system, an environmental monitoring system and an actuating system;
wherein the environmental monitoring system and the actuating system are both connected with the control system; the environmental monitoring system is configured to acquire environmental data; the environmental data includes temperature, humidity, smoke concentration, oxygen content and infrared temperature signals;
the control system is configured to generate a control instruction according to the environmental data; the control instruction includes a water flow control instruction, an exhaust rotating speed control instruction, a power switch instruction and an alarm instruction;
the actuating system is configured to perform corresponding action processing according to the control instruction.

2. The digital control device based on artificial intelligence according to claim 1, wherein the environmental monitoring system comprises a humidity monitoring module, a temperature monitoring module, an oxygen content monitoring module, a smoke monitoring module, and an infrared temperature monitoring module;
the humidity monitoring module, the temperature monitoring module, the oxygen content monitoring module, the smoke monitoring module and the infrared temperature monitoring module are all connected with the control system.

3. The digital control device based on artificial intelligence according to claim 1, wherein the actuating system comprises an alarm module, a hot and cold water flow control module, an exhaust fan rotating speed control module and a main power switch module;
the alarm module, the hot and cold water flow control module, the exhaust fan rotating speed control module and the main power switch module are all connected with the control system.

4. The digital control device based on artificial intelligence according to claim 1, wherein the control system comprises an information processing module, an AI control module and a central processing unit;
the information processing module is connected with the environmental monitoring system and the central processing unit, respectively; the AI control module is connected with the actuating system and the central processing unit, respectively;
the information processing module is configured to preprocess the environmental data; the central processing unit is configured to generate a control signal according to the processed environmental data; and the AI control module is configured to generate the control instruction according to the control signal.

5. The digital control device based on artificial intelligence according to claim 4, wherein the control system further comprises a storage module and a wireless signal transmission module;
the storage module and the wireless signal transmission module are both connected with the central processing unit; the storage module is configured to store the preprocessed environmental data; and the wireless transmission module is configured to communicate with a remote terminal.

6. The digital control device based on artificial intelligence according to claim 5, wherein the remote terminal is a mobile client.

7. The digital control device based on artificial intelligence according to claim 4, further comprising an auxiliary system;
wherein the auxiliary system is connected with the central processing unit.

8. The digital control device based on artificial intelligence according to claim 7, wherein the auxiliary system comprises a display module, a voice playing module, a control switch module and an instruction input module;
the display module, the voice playing module, the control switch module and the instruction input module are all connected with the central processing unit.

9. The digital control device based on artificial intelligence according to claim 1, further comprising: a shell;
the control system and the actuating system are provided with the environmental data inside the shell.

10. The digital control device based on artificial intelligence according to claim 9, wherein the shell is provided with a side flip cover.
